(19) United States
(12) Patent Application Publication
(10) Pub. No.: US 2026/0189453 A1
(43) Pub. Date: Jul. 2, 2026

(54) DIAGNOSTIC SYSTEM, DEVICE AND METHOD FOR COMMUNICATION BEHAVIOR

(71) Applicant: MOXA INC., NEW TAIPEI CITY (TW)

(72) Inventors: KUN-LUNG LIAO, NEW TAIPEI CITY (TW); JIAN-YUAN CHEN, NEW TAIPEI CITY (TW); HSING-HAN LIU, NEW TAIPEI CITY (TW)

(21) Appl. No.: 19/174,890

(22) Filed: Apr. 9, 2025

(30) Foreign Application Priority Data
Dec. 26, 2024 (TW) 113150951

(51) Int. Cl. H04L 41/0631; H04L 41/149; H04L 43/04

(52) U.S. Cl. CPC H04L 41/0631; H04L 41/149; H04L 43/04

(57) ABSTRACT

A diagnostic system for communication behavior is provided. The diagnostic system includes a wireless device configured to communicate with an intranet, and a diagnostic device. The diagnostic device includes a data receiving module, a pattern identification module, an event detection module, and a processing module. The data receiving module is configured to receive at least one log data from the wireless device. The pattern identification module is configured to receive the log data and identify whether the log data has at least one key pattern of data. The event detection module is configured to obtain an event corresponding to the key pattern of data. The event represents a communication behavior of the wireless device. The processing module is configured to perform a specific operation corresponding to the event.

### CROSS REFERENCE TO RELATED APPLICATIONS

This application claims priority to Taiwan Application No. 113150951 filed on Dec. 26, 2024, which is incorporated by reference in its entirety.

### TECHNICAL FIELD

The present disclosure relates to diagnosis for a communication behavior, and more particularly to a diagnostic system, device and method for a communication behavior of a wireless device.

### BACKGROUND

In a current communication system, especially in a closed network environment, in case of failures during communication, offline data analysis using a high-performance external device needs to be performed by system maintenance staff knowledgeable in the field of wireless communications. Conventionally, enterprises have a preference of configuring wireless infrastructure in a private environment that is not randomly open to external access. Thus, in order to obtain analysis data, system maintenance staff of equipment providers often need to relocate a high-performance host to the site, or access part of equipment on the site by an external cloud host in an encrypted manner, resulting in difficulties in data acquisition as well as inabilities of fixing connection problems of a communication system in real-time by system maintenance staff. Moreover, due to an immense amount of messages in log data provided by a communication system, even if assistance is provided to analyze contents of the log data of system maintenance staff, it is frequent that the problem cannot be efficiently identified.

Therefore, devices and methods capable of immediately diagnosing communication system and identifying communication behaviors are desired.

### SUMMARY OF THE INVENTION

The present application discloses a diagnostic system for a communication behavior. The diagnostic system includes a wireless device configured to communicate with a wireless network, and a diagnostic device. The diagnostic device includes a data receiving module configured to receive at least one log data from the wireless device, a pattern identification module configured to receive and identify whether the log data includes at least one key pattern of data, an event detection module configured to match at least one event corresponding to the key pattern of data, wherein the event represents a communication behavior of the wireless device, and a processing module configured to perform at least one specific operation corresponding to the event.

Furthermore, the present disclosure discloses a diagnostic device for analyzing a communication behavior of a wireless device. The diagnostic system includes a data receiving module configured to receive at least one log data from the wireless device, a pattern identification module configured to receive and identify whether the log data includes at least one key pattern of data, an event detection module configured to match at least one event corresponding to the key pattern of data, and a processing module configured to perform at least one specific operation corresponding to the event. The event represents a communication behavior of the wireless device.

Moreover, the present disclosure discloses a diagnostic method for analyzing a communication behavior of a wireless device. At least one log data from the wireless device is obtained, wherein the log data includes a sequence consisting of a plurality of log terms. It is identified whether at least one of the log terms in the log data matches at least one key pattern of data. An event corresponding to the key pattern of data is obtained. A specific operation corresponding to the event is performed to connect the wireless device.

### BRIEF DESCRIPTION OF THE DRAWINGS

Aspects of the present disclosure are best understood from the following detailed description when read with the accompanying drawings. It is noted that, in accordance with the common practice in the industry, various features are not drawn to scale. In fact, the dimensions of various features may be arbitrarily increased or reduced for clarity of discussion.

FIG. 1 is a diagnostic system for a communication behavior according to an embodiment of the present disclosure.

FIG. 2A and FIG. 2B are schematic diagrams of logs according to an embodiment of the present disclosure.

FIG. 3A is a schematic diagram of a pattern table according to an embodiment of the present disclosure.

FIG. 3B is a schematic diagram of an event table according to an embodiment of the present disclosure.

FIG. 4 is a schematic diagram of operations in different stages of a diagnostic device according to an embodiment of the present disclosure.

FIG. 5 is a flowchart of registration to a network by a wireless device according to an embodiment of the present disclosure.

FIG. 6 is a flowchart of a diagnostic method according to an embodiment of the present disclosure.

### DETAILED DESCRIPTION

Some variations of the embodiments are described. Throughout the various views and illustrative embodiments, like reference numbers are used to designate like devices. It should be understood that additional operations can be provided before, during, and/or after a disclosed method, and some of the operations described can be replaced or eliminated for other embodiments of the method.

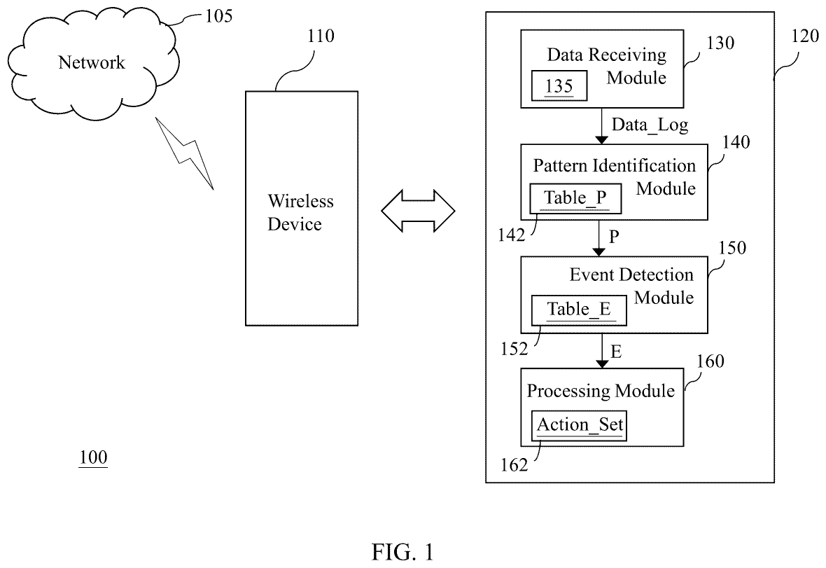

FIG. 1 shows a diagnostic system 100 for a communication behavior according to an embodiment of the present disclosure. The diagnostic system 100 includes a wireless device 110 and a diagnostic device 120. The wireless device 110 is configured to establish a connection with a network 105. The network 105 is a wireless network. In some embodiments, the network 105 may be an intranet inaccessible by the Internet, and is, for example, an enterprise network, an internal internet or a public internet. The diagnostic device 120 is connected in a wired or wireless manner to the wireless device 110, and is configured to analyze (or parse) a communication state of the wireless device 110 and the network 105. The diagnostic device 120 is not limited to being discrete outside the wireless device 110, but may also be built inside the wireless device 110. According to an analysis result, the diagnostic device 120 is capable of automatically adjusting or notifying system maintenance staff to troubleshoot the problem, hence rendering more smooth wireless transmissions between the wireless device 110 and the network 105.

In some embodiments, the wireless device 110 may be, for example but not limited to, user equipment (UE), a low-cost device (e.g., a machine-type communication (MTC)) device), a device-to-device (D2D) communication device, a narrow-band Internet-of-Things (NB-IoT) device, a power device, a server, a mobile phone, various types of computers (e.g., a desktop computer, a laptop computer and a tablet computer), an e-book, and a portable computer system, or any combination of the devices above.

The diagnostic device 120 includes a data receiving module 130, a pattern identification module 140, an event detection module 150 and a processing module 160. The data receiving module 130 includes a communication interface circuit 135. The communication interface circuit 135 is configured to communicate in a wired or wireless manner with the wireless device 110, so as to obtain a log data Data_Log from the wireless device 110. In some embodiments, the communication interface circuit 135 may be a Universal Serial Bus (USB) module, an Ethernet module or a Bluetooth module. Moreover, during the communication between the wireless device 110 and the network 105, the log data Data_Log is the state or operation information of the wireless device 110 recorded as time elapses during an operation period. For example, when the wireless device 110 initiates a connection request, the wireless device 110 immediately outputs one log data Data_Log to the data receiving module 130. In some embodiments, the log data Data_Log from the wireless device 110 is raw data, that is, non-decoded data.

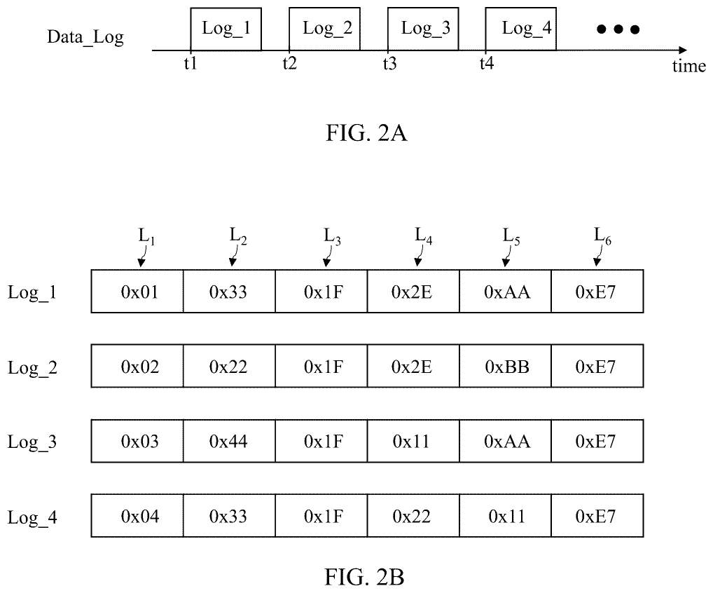

Referring to FIG. 2A and FIG. 2B, FIG. 2A and FIG. 2B show schematic diagrams of the log data Data_Log according to an embodiment of the present disclosure. In this embodiment, the data receiving module 130 sequentially receives four log data Data_Log at four timings t1, t2, t3 and t4. The four log data Data_Log are respectively denoted as Log_1, Log_2, Log_3 and Log_4, and may be in a raw data format that is not necessarily limited to readily human-readable logs. In some embodiments, the timings t1, t2, t3 and t4 have same time intervals. In some embodiments, the intervals among the timings t1, t2, t3 and t4 may be variable. Moreover, each of the log data Log_1, Log_2, Log_3 and Log_4 is a sequence consisting of multiple log terms L. In this embodiment, each of the logs Log_1, Log_2, Log_3 and Log_4 is a sequence consisting of log terms L₁ to L₆. For example, the log term L₁ is the first log term in a sequence, and the log term L₆ is the last term in the sequence. In this embodiment, the number of the log terms L₁ to L₆ is merely an example. In other embodiments, the log data Data_Log may include more or less of log terms L.

Again referring to FIG. 1, the pattern identification module 140 includes a memory 142, which is configured to store a pattern table Table_P storing multiple key patterns of data P. The pattern identification module 140 is configured to identify (or compare) each log data Data_Log according to the pattern table Table_P in the memory 142, so as to determine whether the log data Data_Log includes the key pattern of data P. When the key pattern of data P is identified from the log data Data_Log, the pattern identification module 140 is configured to transmit the identified key pattern of data P to the event detection module 150. Conversely, when no key pattern of data P is identified from the log data Data_Log, no key pattern of data P is transmitted to the event detection module 150. In other words, the pattern identification module 140 is configured to filter each log data Data_Log from the data receiving module 130, so as to identify and regard any log data Data_Log with the key pattern of data P as valid data for subsequent analysis.

In some embodiments, each key pattern of data P may also be a combination of one or more log terms L, as shown in the equations below:

$${L}_{x} ⇒ {P}_{i} ; \qquad equation ( 1 )$$

$$\{ L {x}_{} \hat{} {L}_{y} \} ⇒ {P}_{i} ; \qquad equation ( 2 )$$

$$or$$

$$\{ L {x}_{} \hat{} {L}_{x} \hat{} {L}_{y} \vert {L}_{x} \hat{} {L}_{y} \hat{} {L}_{z} \vert … ⇒ {P}_{i} . \qquad equation ( 3 )$$

In equation (1) to equation (3), Pᵢ is the i^{th} key pattern of data P in the pattern table Table_P, and Lₓ, L_{y} and L_{z} are respectively the x^{th}, y^{th} and z^{th} log terms in the log data Data_Log. For example, the key pattern of data Pᵢ in equation (1) represents that the log term Lₓ in the log data Data_Log has a specific key pattern. The key pattern of data Pᵢ in equation (2) represents that, in the log data Data_Log, the log term Lₓ has a first key pattern and the log term L_{y} has a second key pattern. The key pattern of data Pᵢ in equation (3) includes at least three situations below: (1) the log term Lₓ in the log data Data_Log has a first key pattern; (2) the log terms Lₓ and L_{y} have first and second key patterns, respectively; and (3) the log terms Lₓ, L_{y} and L_{z} have first, second and third key patterns, respectively. The combinations of the log terms L in equation (1) to equation (3) are merely examples and are not for limiting the present disclosure.

The event detection module 150 includes a memory 152, which is configured to store an event table Table_E having multiple events E. The event detection module 150 is configured to detect one or more key patterns of data P in the valid log data Data_Log according to the event table Table_E in the memory 150, so as to identify the corresponding event E according to the key pattern of data P, wherein the event E represents a communication behavior of the wireless device 110 at that time and may also be referred to as a communication behavior event E. Upon detecting the event E according to the identified key pattern of data P, the event detection module 150 is configured to notify the processing module 160 for the event E. Once the event E is received, the processing module 160 is configured to determine a specific communication behavior having occurred at the wireless device 110 and perform an operation corresponding to the event E according to an operation setting Action_Set stored in a memory 162, so as to immediately and efficiently control related modules of the wireless device 110 in response to the anticipated event E, and ensure the stability between the wireless device 110 and the network 105. In other words, the event detection module 150 finds a match for each key pattern of data P from the pattern identification module 140 to identify the corresponding event E, and notifies the processing module 160 to perform an immediate corresponding operation to maintain the communication between the wireless device 110 and the network 105. Moreover, the event E includes various possible communication behaviors of the wireless device 110 under normal communications and/or abnormal communications.

In some embodiments, each even E may be a combination of one or more key patterns of data P, as shown in the equations below:

$${P}_{x} ⇒ {E}_{i} ; \qquad equation ( 4 )$$

$$\{ P {x}_{} \hat{} ( Δ t ) {P}_{y} \} ⇒ {E}_{i} ; \qquad equation ( 5 )$$

$$\{ P {x}_{} \vert {P}_{x} \hat{} {P}_{y} \vert {P}_{x} \hat{} {P}_{y} \hat{} {P}_{y} \hat{} {P}_{z} \vert … ⇒ {E}_{i} ; \qquad equation ( 6 )$$

$$or$$

$$\{ P {x}_{} \vert {P}_{x} \hat{} ( Δ t ) {P}_{y} \vert {P}_{x} \hat{} ( Δ {t}_{1} ) {P}_{y} \hat{} ( Δ {t}_{2} ) {P}_{z} \vert … \} ⇒ {E}_{i} . \qquad equation ( 7 )$$

In equation (4) to equation (7), E; is the i^{th} event E in the event table Table_E, and Pₓ, P_{y} and P_{z} are respectively the x^{th}, y^{th} and z^{th} key patterns of data in the pattern table Table_P. Moreover, Δt represents an interval time. For example, the event Eᵢ in equation (4) represents that the log data Data_Log has a key pattern of data Pₓ. The event Eᵢ in equation (5) represents that the first log data Data_Log has the key pattern of data Pₓ, and the second log data Data_Log after the interval time Δt has elapsed has the key pattern of data P_{y}. The event Eᵢ in equation (6) includes at least three situations below: (1) the log data Data_Log has a key pattern of data Pₓ; (2) the first log data Data_Log has the key pattern of data Pₓ, and the second log data Data_Log has the key pattern of data P_{y}; and (3) the first log data Data_Log has the key pattern of data Pₓ, the second log data Data_Log has the key pattern of data P_{y}, the third log data Data_Log has the key pattern of data P_{z}. The event E; in equation (7) includes at least three situations below: (1) the log data Data_Log has a key pattern of data Pₓ; (2) the first log data Data Log has the key pattern of data Pₓ, and the second log data Data_Log after the interval time Δt has elapsed has the key pattern of data P_{y}; and (3) the first log data Data_Log has the key pattern of data Pₓ, the second log data Data_Log after the interval time Δt1 has elapsed has the key pattern of data P_{y}, the third log data Data Log after the interval time Δt2 has elapsed has the key pattern of data P_{z}. The combinations of the key pattern of data P in equation (4) to equation (7) are merely examples and are not for limiting the present disclosure.

In some embodiments, the diagnostic device 120 further includes a storage device (not shown), for example, a hard drive or a memory, configured to store the large amount of log data Data_Log received. The non-real-time log data Data_Log stored may be exported to other devices in a wired or wireless manner for further analysis, for example, for system maintenance staff to track events having occurred in the wireless device 110. Moreover, according to new key pattern of data P and corresponding events E obtained from the analysis above, system maintenance staff may update the pattern table Table_P, the event table Table_E and the corresponding operation setting Action_Set of the diagnostic device 120.

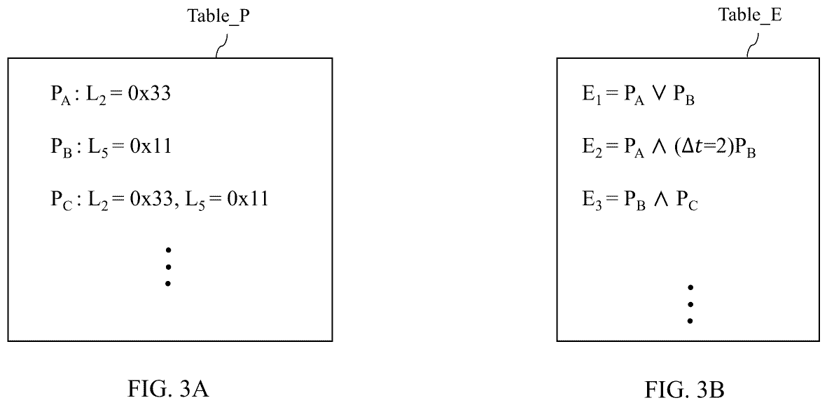

FIG. 3A shows a schematic diagram of a pattern table Table_P according to an embodiment of the present disclosure. In FIG. 3A, the key pattern of data P_{A} represents that the value of the key pattern of the log term L₂ in the log data Data_Log is 0x33. Thus, upon identifying the value of the log term L₂ as 0x33, the pattern identification module 140 determines that the log data Data_Log has the key pattern of data P_{A}, and notifies the event detection module 150. Moreover, the key pattern of data P_{B} represents that the value of the key pattern of the log term L₅ in the log data Data_Log is 0x11. The key pattern of data P_{C} represents that the values of the key pattern of the log terms L₂ and L₃ in the log data Data_Log are 0x33 and 0x11, respectively.

FIG. 3B shows a schematic diagram of the event table Table_E according to an embodiment of the present disclosure. The event table Table_E in FIG. 3B corresponds to the pattern table Table_P in FIG. 3A. In FIG. 3B, the event Eᵢ represents that the log data Data_Log has the key pattern of data P_{A} or P_{B} in FIG. 3A. The event E₂ represents that one log data Data_Log has the key pattern of data P_{A}, and another log data Data_Log after a predetermined time (for example, Δt=2) has elapsed has the key pattern of data P_{B}. The event E₃ represents that the log data Data_Log has the key patterns of data P_{B} and P_{C}.

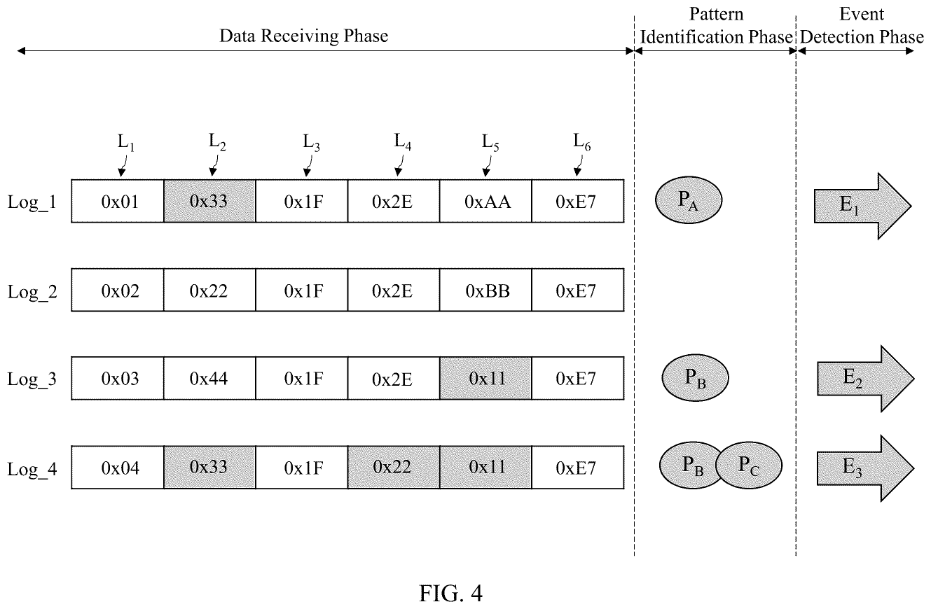

FIG. 4 shows a schematic diagram of operations in different phases of the diagnostic device 120 according to an embodiment of the present disclosure. First, in a data receiving phase, the data receiving module 130 of the diagnostic device 120 sequentially receives the log data Log_1, Log_2, Log_3 and Log_4 from the wireless device 110.

In a pattern identification phase, the pattern identification module 140 of the diagnostic device 120 performs identification on each of the log terms L₁ to L₀ of the logs Log_1, Log_2, Log_3 and Log_4 according to the pattern table Table_P in FIG. 3A. For example, upon receiving the log Log_1, the pattern identification module 140 identifies according to the pattern table Table_P in FIG. 3A that the log data Log_1 has the key pattern of data P_{A}, that is, the value of the log term L₂ is 0x33. Upon receiving the log data Log_2, the pattern identification module 140 identifies that the log Log_2 has no key pattern of data, and thus no subsequent analysis is performed on the log data Log_2. Upon receiving the log data Log_3, the pattern identification module 140 identifies according to the pattern table Table_P in FIG. 3A that the log data Log_3 has the key pattern of data P_{B}, that is, the value of the log term L₅ is 0x11. Upon receiving the log data Log_4, the pattern identification module 140 identifies according to the pattern table Table_P in FIG. 3A that the log data Log_4 has the key patterns of data P_{B} and P_{C}, that is, the values of the log terms L₂, L₄ and L₅ are 0x33, 0x22 and 0x11, respectively.

In an event detection phase, the event detection module 150 of the diagnostic device 120 performs detection (or matching) on each key pattern of data P according to the event table Table_E in FIG. 3B to obtain the corresponding event E. For example, for the key pattern of data P_{A} of the log data Log_1, the event detection module 150 detects according to the event table Table_E in FIG. 3B that the log data Log_1 includes the event E₁. Since the log data Log_2 does not include any key pattern of data, the event detection module 150 does not perform detection on the log data Log_2. For the key patterns of data P_{A} and P_{B} of the log data Log_1 and Log_3, the event detection module 150 detects that the log data Log 1 and Log_3 include the event E₂ according to the event table Table_E in FIG. 3B. For the key patterns of data P_{B} and P_{C} of the log data Log_4, the event detection module 150 detects that the log data Log_4 includes the event E₃ according to the event table Table_E in FIG. 3B.

In some embodiments, once the event E is received, the processing module 160 may then notify the wireless device 110 according to the operation setting Action_Set stored in the memory 162 to adjust communication settings of the wireless device 110, such as switching a SIM card or changing a frequency band. In some embodiments, once the event E is received, the processing module 160 may then immediately notify system maintenance staff according to the operation setting Action_Set stored in the memory 162, for example, issuing a warning by means of an email or a message, so that system maintenance staff can fix the communication between the wireless device 110 and the network 105 in real time. Thus, by analyzing the log data Data_Log, the diagnostic device 120 can provide more efficient and definite event analysis, so as to reinforce the communication reliability of the wireless device 110 in real time and achieving more reliable wireless transmissions between the wireless device 110 and the network 105.

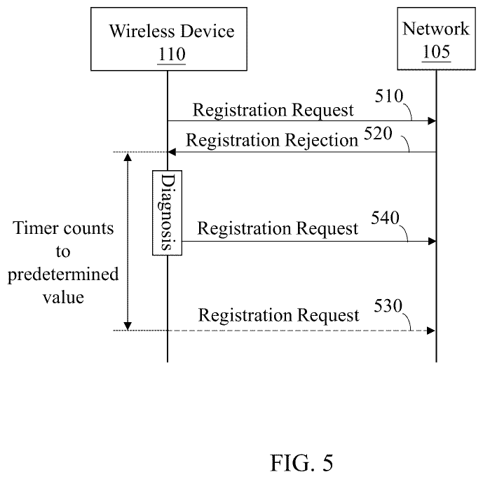

FIG. 5 shows a flowchart of registration to the network 105 by the wireless device 110 according to an embodiment of the present disclosure. As described above, the wireless device 110 is connected in a wired or wireless means to the diagnostic device 120, and continually provides the log data Data_Log to the diagnostic device 120. First, the wireless device 110 sends a registration request 510 to the network 105 (for example, a base station) to request for a connection to the network 105. Due to the occurrence of an abnormal condition, the network 105 declines the registration request 510 of the wireless device 110, and provides a registration rejection 520 to the wireless device 110, wherein the registration rejection 520 includes reasons for declining the registration, for example, a failure cause #19 (abnormal network) in 3GPP communications. In a communication system, when a registration rejection such as cause #19 is received, the wireless device 110 needs to activate a timer to time, and the registration request 530 can be sent to the network 105 again only when the timer times/counts up to a predetermined value (for example, 12 minutes). In an embodiment of the present disclosure, the diagnostic device 120 may obtain the event E corresponding to the registration rejection 520 from the log data Data_Log of the wireless device 110, and perform a corresponding operation. For example, assuming that the wireless device 110 is configured with multiple SIM cards, the diagnostic device 120 notifies the wireless device 110 to switch to another SIM card so as to transmit another registration request 540 to the network 105, or notifies system maintenance staff of this event E in a wired or wireless manner for system maintenance staff to be able to immediately head to the site or operate by means of remote control to troubleshoot any connection failure. Thus, compared to the need of timing/counting to a predetermined value and waiting for system maintenance staff to reach the site in order to analyze and troubleshoot a failure, the diagnostic device 120 of the present disclosure is capable of immediately fixing the connection failure between the wireless device 110 and the network 105, hence accelerating the maintenance and repair speed as well as reducing maintenance and repair costs.

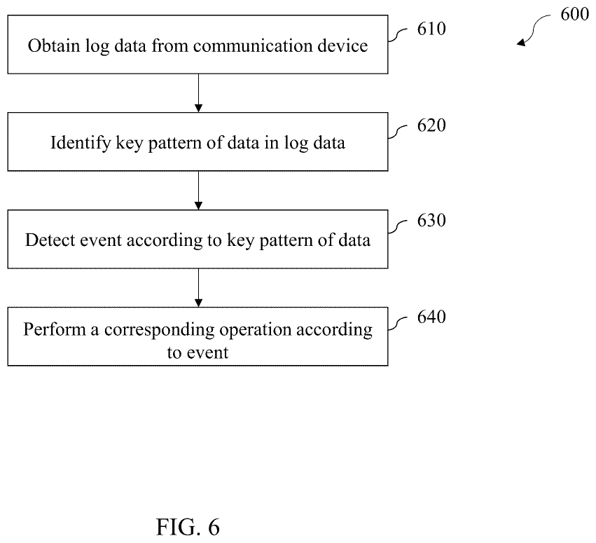

FIG. 6 shows a flowchart of a diagnostic method 600 according to an embodiment of the present disclosure. The diagnostic method 600 may be performed by the diagnostic device 120 in FIG. 1. In operation 610, the data receiving module 130 of the diagnostic device 120 sequentially obtains the log data Data_Log from a communication device (for example, the wireless device 110). In operation 620, the pattern identification module 140 of the diagnostic device 120 performs identification on each log data Data_Log according to the pattern table Table_P set in advance to determine whether the log data Data_Log includes the key pattern of data P, that is, determining whether the log term L in the log data Data_Log matches the key pattern of data P. In operation 630, the event detection module 150 of the diagnostic device 120 performs detection on the identified key pattern of data P according to the event table Table_E set in advance to obtain the event E. In operation 640, the processing module 160 of the diagnostic device 120 performs a corresponding operation or action according to the detected event E and the operation setting Action_Set, so as to immediately troubleshoot the connection failure caused by the event E.

In some embodiments, the pattern table Table_P, the event table Table_E and the operation setting Action_Set are generated by a rule database. In some embodiments, system maintenance staff obtain the pattern table Table_P, the event table Table_E and the operation setting Action_Set according to a communication protocol and an analysis result of the log data Data_Log obtained previously.

Although the preferred embodiments of the present disclosure have been described above, they are not used to limit the present disclosure, and a person having ordinary skill in the art will be able to make certain changes and modifications without departing from the spirit and scope of the disclosure, and thus, the protection scope of the present disclosure is defined by the annexed claims.

What is claimed is:

1. A diagnostic system for a communication behavior, comprising:
a wireless device, configured to communicate with a wireless network; and
a diagnostic device, comprising:
a data receiving module, configured to receive at least one log data from the wireless device;
a pattern identification module, configured to receive and identify whether the log data includes at least one key pattern of data;
an event detection module, configured to match at least one event corresponding to the key pattern of data, wherein the event represents a communication behavior of the wireless device; and
a processing module, configured to perform at least one specific operation corresponding to the event.

2. The diagnostic system of claim 1, wherein the log data comprises a sequence consisting of a plurality of log terms, and the pattern identification module is configured to detect whether each of the log terms has the key pattern of data according to a pattern table.

3. The diagnostic system of claim 2, wherein the event detection module is configured to receive the key pattern of data, and obtain a first event corresponding to the key pattern of data according to an event table.

4. The diagnostic system of claim 3, wherein the processing module is configured to determine that a specific communication behavior is present in the wireless device according to the first event, and notify the wireless device to perform the specific operation.

5. The diagnostic system of claim 4, wherein after the specific operation is performed, the wireless device is configured to keep communicating with the wireless network.

6. The diagnostic system of claim 1, wherein the data receiving module comprises a Universal Serial Bus (USB) module, an Ethernet module or a Bluetooth module, configured to receive the log data from the wireless device.

7. A diagnostic device, for analyzing a communication behavior of a wireless device, comprising:
a data receiving module, configured to receive at least one log data from the wireless device;
a pattern identification module, configured to receive and identify whether the log data includes at least one key pattern of data;
an event detection module, configured to match at least one event corresponding to the key pattern of data, wherein the event represents a communication behavior of the wireless device; and
a processing module, configured to perform at least one specific operation corresponding to the event.

8. The diagnostic device of claim 7, wherein the log data comprises a sequence consisting of a plurality of log terms, and the pattern identification module is configured to detect whether each of the log terms has the key pattern of data according to a pattern table.

9. The diagnostic device of claim 8, wherein the pattern table comprises first key pattern of data corresponding to a first log term, and when the pattern identification module identifies that a value of the first log term in the log data is same as a first key pattern, the log data has the first key pattern of data.

10. The diagnostic device of claim 9, wherein the event detection module is configured to receive the first key pattern of data, and obtain a first event corresponding to the first key pattern of data according to an event table.

11. The diagnostic device of claim 10, wherein the processing module is configured to determine that a specific communication behavior is present in the wireless device according to the first event, and notify the wireless device to perform the specific operation.

12. The diagnostic device of claim 11, wherein after the specific operation is performed, the wireless device is configured to keep communicating with a wireless network.

13. The diagnostic device of claim 11, wherein when the log data does not have the first key pattern of data, the event detection module is configured to determine that the specific communication behavior is absent in the wireless device.

14. The diagnostic device of claim 9, wherein the pattern table comprises second key pattern of data corresponding to a second log term, and when the pattern identification module identifies that a value of the first log term in the log data is same as a first key pattern and a value of the second log term in a specific log data after a predetermined time has elapsed is same as a second key pattern, the log data and the specific log data have the second key pattern of data.

15. The diagnostic device of claim 8, wherein the pattern table comprises first key pattern of data corresponding to a first log term and a second log term, and when the pattern identification module identifies that values of the first log term and the second log term in the log data are respectively same as a first key pattern and a second key pattern, the log data has the first key pattern of data.

16. The diagnostic device of claim 7, wherein the data receiving module comprises a Universal Serial Bus (USB) module, an Ethernet module or a Bluetooth module, configured to receive the log data from the wireless device.

17. A diagnostic method for analyzing a communication behavior of a wireless device, comprising:
obtaining at least one log data from the wireless device, wherein the log data comprises a sequence consisting of a plurality of log terms;
identifying whether at least one of the log terms of the log data matches at least one key pattern of data;
obtaining an event corresponding to the key pattern of data; and
performing a specific operation corresponding to the event to connect the wireless device to a wireless network.

18. The diagnostic method of claim 17, wherein identifying whether the at least one of the log terms of the log data matches the at least one key pattern of data further comprises:
detecting whether each of the log terms has the key pattern of data according to a pattern table.

19. The diagnostic method of claim 18, wherein the pattern table comprises first key pattern of data corresponding to a first log term,
wherein identifying of whether the at least one of the log terms of the log data matches the at least one key pattern of data further comprises:
identifying that the log data has a first key pattern of data when a value of the first log term in the log data is same as a first key pattern.

20. The diagnostic method of claim 19, wherein obtaining the event corresponding to the key pattern of data further comprises:
obtaining a first event corresponding to the first key pattern of data according to an event table.

21. The diagnostic method of claim 20, wherein performing the specific operation corresponding to the event further comprises:
determining that a specific communication behavior is present in the wireless device according to the first event; and
notifying the wireless device to perform the specific operation for the wireless device to keep communicating with the wireless network.

22. The diagnostic method of claim 21, further comprising:
determining that the specific communication behavior is absent in the wireless device when the log data does not have the first key pattern of data.

23. The diagnostic method of claim 19, wherein the pattern table comprises second key pattern of data corresponding to a second log term,
wherein identifying whether the at least one of the log terms in the log data matches the at least one key pattern of data further comprises:
when a value of the first log term in the log data is same as a first key pattern and a value of the second log term in a specific log data after a predetermined time has elapsed is same as a second key pattern, identifying that the log data and the specific log data have the second key pattern of data.

24. The diagnostic method of claim 18, wherein the pattern table comprises first key pattern corresponding to a first log term and a second log term,
wherein identifying whether the at least one of the log terms in the log data matches the at least one key pattern of data further comprises:
when it is identified that values of the first log term and the second log term in the log data are respectively same as a first key pattern and a second key pattern, identifying that the log data has the first key pattern of data.

25. The diagnostic method of claim 17, wherein obtaining the at least one log data from the wireless device further comprises:
receiving the log data from the wireless device via a Universal Serial Bus (USB) module, an Ethernet module or a Bluetooth module.
